(19) United States
(12) Patent Application Publication
(10) Pub. No.: US 2017/0118501 A1
(43) Pub. Date: Apr. 27, 2017

(54) A SYSTEM AND METHODS THEREOF FOR GENERATING A SYNCHRONIZED AUDIO WITH AN IMAGIZED VIDEO CLIP RESPECTIVE OF A VIDEO CLIP

(71) Applicant: AniView Ltd., Tel Aviv (IL)

(72) Inventor: Tal Melenboim, Ashdod (IL)

(21) Appl. No.: 15/312,532

(22) PCT Filed: Dec. 4, 2014
(86) PCT No.: PCT/IL2014/051054

§ 371 Date: Nov. 18, 2016

Related U.S. Application Data
(60) Provisional application No. 62/023,888, filed on Jul. 13, 2014.

(51) Int. Cl. H04N 21/43; H04N 21/233; H04N 21/8547; H04N 21/242; H04N 21/434; H04N 21/439

(52) U.S. Cl. CPC H04N 21/4307; H04N 21/4345; H04N 21/439; H04N 21/8547; H04N 21/242; H04N 21/233

(57) ABSTRACT

A system is configured to generate synchronized audio with an imagized video clip. The system receives electronically at least one video clip that includes a video data and audio data. The system analyzes the video clip and generates a sequence of images respective thereto. The system generates a unique timing metadata for display of each image with respect to other images of the sequence of images. To each predetermined number of sequential images of the sequence, the system generates a corresponding audio file.

### CROSS REFERENCE TO RELATED APPLICATIONS

This application claims the benefit of U.S. Provisional Application No. 62/023,888 filed on Jul. 13, 2014, the contents of which are herein incorporated by reference for all that it contain.

### TECHNICAL FIELD

The invention generally relates to systems for playing video and audio content, and more specifically to system and methods for converting video content to imagized video content and synchronous audio micro-files.

### BACKGROUND

The Internet, also referred to as the worldwide web (WWW), has become a mass media where the content presentation is largely supported by paid advertisements that are added to web-pages' content. Typically, advertisements displayed in a web-page contain video elements that are intended for display on the user's display device.

Mobile devices such as smartphones are equipped with mobile web browsers through which users access the web. Such mobile web browsers typically cannot display auto-played video clips on mobile web pages. Furthermore, there are multiple video formats supported by different phone manufactures which makes it difficult for the advertisers to know which phone the user has, and what video format to broadcast it with.

It would therefore be advantageous to provide a solution that would overcome the deficiencies of the prior art by providing a unitary video clip format that can be displayed on mobile browsers. It would be further advantageous if such a unitary video clip format will have a synchronized audio.

### BRIEF DESCRIPTION OF THE DRAWINGS

The subject matter that is regarded as the invention is particularly pointed out and distinctly claimed in the claims at the conclusion of the specification. The foregoing and other objects, features and advantages of the invention will be apparent from the following detailed description taken in conjunction with the accompanying drawings.

FIG. 1—is a system for generating a synchronized audio with an imagized video clip respective of video content according to an embodiment;

FIG. 2—is a flowchart of the operation of a system for generating a synchronized audio with an imagized video clip respective of video content according to an embodiment; and,

FIG. 3—is a flowchart of the operation of a system for generating a synchronized audio with an imagized video clip respective of video content according to another embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

The embodiments disclosed by the invention are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

A system is configured to generate synchronized audio with an imagized video clip. The system receives electronically at least one video clip that includes a video data and audio data. The system analyzes the video clip and generates a sequence of images respective thereto. The system generates a unique timing metadata for display of each image with respect to other images of the sequence of images. To each predetermined number of sequential images of the sequence, the system generates a corresponding audio file.

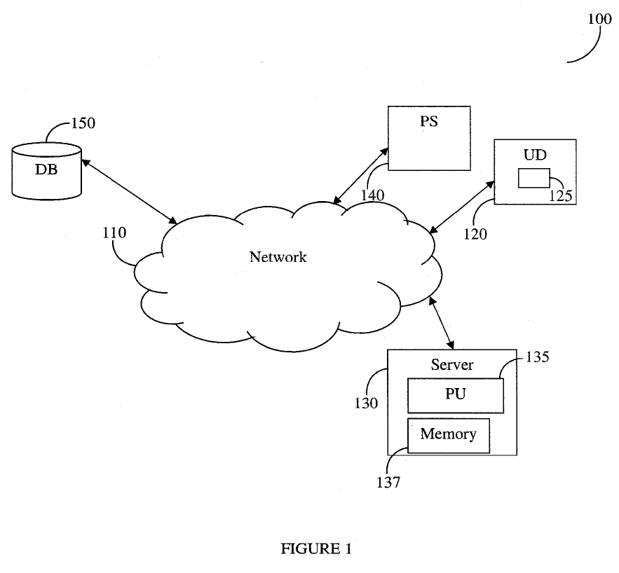

FIG. 1 depicts an exemplary and non-limiting diagram of a system 100 for generating synchronized audio with an imagized video clip respective of a video clip having a video data and audio data embedded therein. The system 100 comprises a network 110 the enables communications between various portions of the system 100. The network may comprise the likes of busses, local area network (LAN), wide area network (WAN), metro area network (MAN), the worldwide web (WWW), the Internet, as well as a variety of other communication networks, whether wired or wireless, and in any combination, that enable the transfer of data between the different elements of the system 100. The system 100 further comprises a user device 120 connected to the network 110. The user device 110 may be, for example but without limitations, a smart phone, a mobile phone, a laptop, a tablet computer, a wearable computing device, a personal computer (PC), smart television and the like. The user device 120 comprises a display unit 125 such as a screen, a touch screen, a combination thereof, etc.

A server 130 is further connected to the network 110. The server 130, typically comprises a processing unit 135, such as processor that is coupled to a memory 137. The memory 137 contains instructions that when executed by the processing unit 135 configures the server 130 to receive over the network 110 a video clip having a video data and audio data embedded therein. The video clip may be received from, for example, a publisher server (PS) 140. The PS 140 is communicatively coupled to the server 130 over the network 110. According to another embodiment, the video data may be received from a first source over the network 110 and the audio data may be received from a second source over the network 110. The server 130 is then configured to generate a sequence of images from the video data of the video clip. The server 130 is further configured to generate for each image of the sequence of images a unique timing metadata for display of each image with respect to other images of the sequence of images. The server 130 is further configured to generate from the audio data a plurality of audio files. Each audio file is corresponding to a predetermined number of sequential images of the sequence of images. The predetermined number of the sequential images is less than the total number of images of the sequence of images.

The server 130 is then configured to associate each of the audio files with the timing metadata of the first image of the predetermined number of images of the sequential images of the sequence of images. The server 130 is then configured to send over the network 110 the imagized video clip and the plurality of audio files to the user device 120 for display on the display of the user device 120.

Optionally, the system 100 further comprises a database 140. The database 140 is configured to store data related to requests received, synchronized audio with imagized video clips, etc.

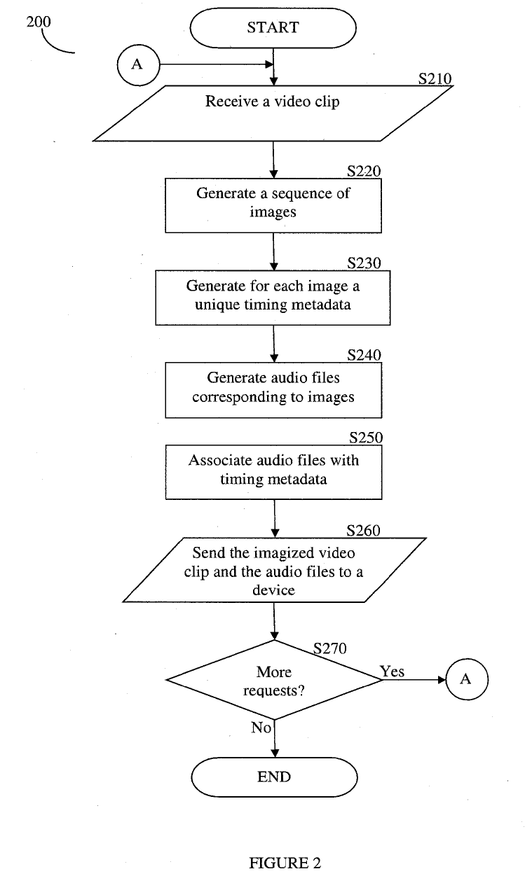

FIG. 2 is an exemplary and non-limiting flowchart 200, of the operation of a system for generating synchronized audio with imagized video clips according to an embodiment. In S210, the operation starts when a video clip having a video data and audio data embedded therein is received over the network 110. In S220, a sequence of images from the video data of the video clip is generated by for example, the server 130.

In S230, for each image a unique timing metadata for display of each image with respect to other images of the sequence of images is generated by the server 130. In S240, a plurality of audio files are generated. Each generated audio file is corresponding to a predetermined number of sequential images of the sequence of images.

In S250, each audio file is associated with the timing metadata of the first image of the predetermined number of images of the sequential images of the sequence of images. In S260, the imagized video clip and the plurality of audio files are sent over the network for display on the display 125 of the user device 120. In S270, it is checked whether additional requests for video content are received from the user device 120 and if so, execution continues with S210; otherwise, execution terminates.

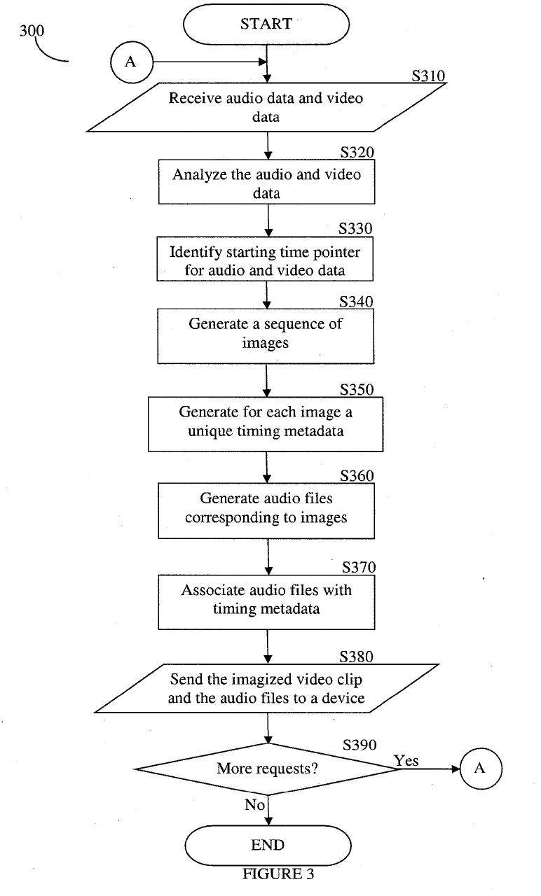

FIG. 3 is an exemplary and non-limiting flowchart 300 of the operation of a system for generating synchronized audio with imagized video clips according to another embodiment. In some cases, while sending a request to display audio or video data on user devices 120, the actual display of the video or audio data is delayed for a certain time, depending on the type of the user device 120. For example, while sending the same audio data for display on an iPhone® device it will take, for example, three seconds for the audio to be played while on Android® device it will take, for example, five seconds for the audio to be played. As the delay time varies, it may harm the synchronization between the audio and the video of the video clip.

In S310, the operation starts when a video data and respective audio data are received from one or more sources through the network 110. In S320, the server 130 analyzes the video data and the audio data of the video clip. In S330, the server 130 identifies a starting time pointer in which the actual video and audio are displayed. In S340, a sequence of images is generated by the server 130 from the video data. In S350, for each image a unique timing metadata for display of each image with respect to other images of the sequence of images is generated by the server 130 respective of the starting time pointer. In 5360, a plurality of audio files are generated from the audio data by the server 130. Each generated audio file is corresponding to a predetermined number of sequential images of the sequence of images. In S370, each audio file is associated with the timing metadata of the first image of the predetermined number of images of the sequential images of the sequence of images respective of the starting time pointer of the audio data. In 5380, the imagized video clip and the plurality of audio files are sent over the network 110 for display on the display 125 of the user device 120. In S390, it is checked whether additional requests for video content are received from the user device 120 and if so, execution continues with S310; otherwise, execution terminates.

The principles of the invention, wherever applicable, are implemented as hardware, firmware, software or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program embodied in non-transitory computer readable medium, or any combination thereof, which may be executed by a CPU, whether or not such computer or processor is explicitly shown. Implementations may further include full or partial implementation as a cloud-based solution. In some embodiments certain portions of a system may use mobile devices of a variety of kinds. In addition, various other peripheral units may be connected to the computer platform such as an additional data storage unit and a printing unit. The circuits described hereinabove may be implemented in a variety of manufacturing technologies well known in the industry including but not limited to integrated circuits (ICs) and discrete components that are mounted using surface mount technologies (SMT), and other technologies. The scope of the invention should not be viewed as limited by the SPPS 110 described herein and other monitors may be used to collect data from energy consuming sources without departing from the scope of the invention.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

1. A computerized method for generating audio with a video clip, the method comprising:
receiving over a communication network a video clip comprising a sequence of images and corresponding audio data;
generating by a processing unit from the audio data a plurality of audio files, each audio file corresponding to a predetermined number of sequential images of the sequence of images, wherein the predetermined number is less than a total number of images of the sequence of images;
associating by the processing unit each of the audio files with timing metadata of a first image of the predetermined number of images of the sequential images of the sequence of images; and
sending over the network the video clip and the plurality of audio files to a user device communicatively connected to the network.

2. The computerized method of claim 1, wherein the audio data is embedded within the video clip.

3. The computerized method of claim 1, further comprising:
analyzing the audio data and the sequence of images; and
identifying a starting time pointer of each of the audio data and the sequence of images.

4. The computerized method of claim 1, wherein at least the video clip is received from a publisher server.

5. The computerized method of claim 1, wherein the user device is one of: a smart phone, a mobile phone, a laptop, a tablet computer, a wearable computing device, a personal computer (PC), and a smart television.

6. A non-transitory computer readable medium having stored thereon instructions for causing one or more processing units to:
receive over a communication network a video clip comprising a sequence of images and corresponding audio data;
generate by a processing unit from the audio data a plurality of audio files, each audio file corresponding to a predetermined number of sequential images of the sequence of images, wherein the predetermined number is less than a total number of images of the sequence of images;
associate by the processing unit each of the audio files with timing metadata of a first image of the predetermined number of images of the sequential images of the sequence of images; and
send over the network the video clip and the plurality of audio files to a user device communicatively connected to the network.

7. A computerized method for generating synchronized audio with a video clip, the method comprising:
receiving over a communication network a video clip having video data and audio data embedded therein;
generating by a processing unit a sequence of images from the video data of the video clip;
generating by the processing unit for each image unique timing metadata for display of each image with respect to other images of the sequence of images;
generating by the processing unit from the audio data a plurality of audio files, each audio file corresponding to a predetermined number of sequential images of the sequence of images, wherein the predetermined number is less than a total number of images of the sequence of images;
associating by the processing unit each of the audio files with the timing metadata of a first image of the predetermined number of images of the sequential images of the sequence of images; and,
sending over the network the video clip and the plurality of audio files to a user device communicatively connected to the network.

8. The computerized method of claim 7, further comprising:
analyzing the audio data and the sequence of images; and
identifying a starting time pointer of each of the audio data and the sequence of images.

9. The computerized method of claim 7, wherein the video clip is received from a publisher server.

10. The computerized method of claim 7, wherein the user device is one of: a smart phone, a mobile phone, a laptop, a tablet computer, a wearable computing device, a personal computer (PC) and a smart television.

11. A non-transitory computer readable medium having stored thereon instructions for causing one or more processing units to:
receive over a communication network a video clip having video data and audio data embedded therein;
generate by a processing unit a sequence of images from the video data of the video clip;
generate by the processing unit for each image unique timing metadata for display of each image with respect to other images of the sequence of images;
generate by the processing unit from the audio data a plurality of audio files, each audio file corresponding to a predetermined number of sequential images of the sequence of images, wherein the predetermined number is less than a total number of images of the sequence of images;
associate by the processing unit each of the audio files with the timing metadata of a first image of the predetermined number of images of the sequential images of the sequence of images; and,
send over the network the video clip and the plurality of audio files to a user device communicatively connected to the network.

12. An server configured to generate synchronized audio with a video clip, the server comprising:
a network interface to a network;
a processing unit connected to the network interface; and
a memory connected to the processing unit, the memory containing instructions therein that when executed by the processing unit configure the server to:
receive over a communication network a video clip having video data and audio data embedded therein;
generate a sequence of images from the video data of the video clip;
generate for each image unique timing metadata for display of each image with respect to other images of the sequence of images;
generate from the audio data a plurality of audio files, each audio file corresponding to a predetermined number of sequential images of the sequence of images, wherein the predetermined number is less than a total number of images of the sequence of images;
associate each of the audio files with the timing metadata of a first image of the predetermined number of images of the sequential images of the sequence of images; and
send over the network the video clip and the plurality of audio files to a user device communicatively connected to the network.

13. The server of claim 12, wherein the video clip is received from a publisher server.

14. The server of claim 12, wherein the user device is one of: a smart phone, a mobile phone, a laptop, a tablet computer, a wearable computing device, a personal computer (PC), and a smart television.

15. A server configured to generate synchronized audio with a video clip, the server comprising:
a network interface to a network;
a processing unit connected to the network interface; and
a memory connected to the processing unit, the memory containing instructions therein that when executed by the processing unit configure the server to:
receive over a communication network a video clip comprising a sequence of images and corresponding audio data;
generate from the audio data a plurality of audio files, each audio file corresponding to a predetermined number of sequential images of the sequence of images, wherein the predetermined number is less than a total number of images of the sequence of images;
associate each of the audio files with timing metadata of a first image of the predetermined number of images of the sequential images of the sequence of images; and
send over the network the video clip and the plurality of audio files to a user device communicatively connected to the network.

16. The server of claim 15, wherein the audio data is embedded within the video clip.

17. The server of claim 15, wherein the memory further contains instructions that when executed by the processing unit configures the server to:
analyze the audio data and the sequence of images; and
identify a starting time pointer of each of the audio data and the sequence of images.

18. The server of claim 15, wherein at least the video clip is received from a publisher server.

19. The server of claim 15, wherein the user device is one of: a smart phone, a mobile phone, a laptop, a tablet computer, a wearable computing device, a personal computer (PC), and a smart television.
